(19) United States
(12) Patent Application Publication
(10) Pub. No.: US 2024/0079960 A1
(43) Pub. Date: Mar. 7, 2024

(54) VOLTAGE CONVERSION DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Arata NAKASHIMA, Yokkaichi-shi, Mie (JP)

(21) Appl. No.: 17/754,644

(22) PCT Filed: Aug. 28, 2020
(86) PCT No.: PCT/JP2020/032637

§ 371 Date: Apr. 7, 2022

(30) Foreign Application Priority Data
Oct. 10, 2019 (JP) 2019-186579

(51) Int. Cl. H02M 3/158; H02M 1/00; H02M 1/08; H02M 1/34

(52) U.S. Cl. CPC H02M 3/1582; H02M 1/0009; H02M 1/08; H02M 1/34

(57) ABSTRACT

A voltage conversion device determines a usage duty based on the minimum value of candidates that include a first candidate duty and a second candidate duty if the direction of current flowing through at least one of a first conductive path and a second conductive path is a first current direction. The voltage conversion device determines a usage duty based on the maximum value of candidates that include the first candidate duty and a third candidate duty if the direction of current flowing through at least one of the conductive paths is a second current direction.

### CROSS-REFERENCE TO RELATED APPLICATIONS

This application is the U.S. national stage of PCT/JP2020/032637 filed on Aug. 28, 2020, which claims priority of Japanese Patent Application No. JP 2019-186579 filed on Oct. 10, 2019, the contents of which are incorporated herein.

### TECHNICAL FIELD

The present disclosure relates to a voltage conversion device.

### BACKGROUND

Heretofore, voltage conversion devices that can step down a voltage input from the high voltage side and output the stepped down voltage to the low voltage side, and can step up a voltage input from the low voltage side and output the stepped up voltage to the high voltage side are known. A step up/down converter described in JP 2015-77933A is provided with a voltage conversion unit and a microcomputer that controls the drive of this voltage conversion unit, for example. This microcomputer can detect the voltage value on a 12 V side (low voltage side) and a 48 V side (high voltage side), and, can step-down drive and step-up drive the voltage conversion unit, based on respective detected voltage values.

The step up/down converter can step-down operate the voltage conversion unit by providing a step-down PWM signal to the voltage conversion unit, and step-up operate the voltage conversion unit by providing a step-up PWM signal to the voltage conversion unit. However, if this step up/down converter switches to the other operation in a situation where one of a step-up operation and a step-down operation is being executed, there is a problem in that it takes a long time for transition processing for switching to the other operation. The transition processing includes a process for determining whether or not to switch an operation mode, a signal switching process for temporarily stopping a PWM signal for the one of the operations and regenerating a PWM signal for the other operation, and the like, and thus the transition processing requires a certain amount of time.

In order to resolve at least one of the above-described issues, the present disclosure realizes a voltage conversion device capable of limiting excessive current regardless of the direction in which current flows, while realizing the function of shortening the time it takes to switch between the step-down operation and the step-up operation.

### SUMMARY

A voltage conversion device according to a first aspect of this disclosure includes: a voltage conversion unit; a first voltage value detection unit; a first current value detection unit; a second voltage value detection unit; a determination unit; and a drive unit. The voltage conversion unit includes a high-side switch, a low-side switch, and an inductor, and that is configured to perform voltage conversion between a first conductive path and a second conductive path. The first voltage value detection unit is configured to detect a first voltage value that is a voltage value of the first conductive path. The first current value detection unit is configured to detect a first current value that is a value of current flowing through the first conductive path. The second voltage value detection unit is configured to detect a second voltage value that is a voltage value of the second conductive path. The second current value detection unit is configured to detect a second current value that is a value of current flowing through the second conductive path. The determination unit is configured to determine a usage duty based on the first voltage value, the second voltage value, the first current value, and the second current value. The drive unit is configured to input a first control signal that is based on the usage duty determined by the determination unit to the high-side switch, and to input a second control signal that is based on a signal obtained by inverting the first control signal to the low-side switch, in which the voltage conversion unit is configured to perform at least a step-down operation for stepping down a voltage applied to the first conductive path through an on/off operation of the high-side switch and applying an output voltage to the second conductive path, and a step-up operation for stepping up a voltage applied to the second conductive path through an on/off operation of the low-side switch and applying an output voltage to the first conductive path. The determination unit is configured to: (1) define a first candidate duty based on a larger value or a smaller value out of a value obtained by subtracting a first duty from 100 percent, and a value of a second duty out of the first study and the second duty the first duty being a duty for approximating the voltage value of the first conductive path to a voltage target value of the first conductive path, and the second duty being a duty for approximating the voltage value of the second conductive path to a voltage target value of the second conductive path; (2) define a second candidate duty for limiting a current value in a first current direction from the first conductive path to the second conductive path, based on at least a current target value in the first current direction in one of the first conductive path and the second conductive path and a current value of the one of the conductive paths; (3) define a third candidate duty for limiting a current value in a second current direction opposite to the first current direction, based on at least a current target value in the second current direction in the one of the conductive paths and the current value of the one of the conductive paths; (4) determine the usage duty based on the minimum value of candidates that include the first candidate duty and the second candidate duty if the direction of current flowing through at least one of the first conductive path and the second conductive path is the first current direction; and (5) determine the usage duty based on the maximum value of candidates that include the first candidate duty and the third candidate duty if the direction of current flowing through at least one of the first conductive path and the second conductive path is the second current direction.

A voltage conversion device according to a second aspect of this disclosure includes: a voltage conversion unit, a first voltage value detection unit, a first current value detection unit, a second current value detection unit, a determination unit, and a drive unit. The voltage conversion unit includes a high-side switch, a low-side switch, and an inductor, and that is configured to perform voltage conversion between a first conductive path and a second conductive path. The first voltage value detection unit is configured to detect a first voltage value that is a voltage value of the first conductive path. The first current value detection unit is configured to detect a first current value that is a value of current flowing through the first conductive path. The second voltage value detection unit is configured to detect a second voltage value that is a voltage value of the second conductive path. The second current value detection unit is configured to detect a second current value that is a value of current flowing through the second conductive path. The determination unit is configured to determine a usage duty based on the first voltage value, the second voltage value, the first current value, and the second current value. The drive unit is configured to input a PWM control signal that is based on the usage duty determined by the determination unit to the low-side switch, and to input an inverted control signal that is based on a signal obtained by inverting the PWM control signal to the high-side switch, in which the voltage conversion unit is configured to perform at least a step-down operation for stepping down a voltage applied to the second conductive path through an on/off operation of the high-side switch and applying an output voltage to the first conductive path, and a step-up operation for stepping up a voltage applied to the first conductive path through an on/off operation of the low-side switch and applying an output voltage to the second conductive path, and the determination unit is configured to: (1) define a first candidate duty based on a larger value or a smaller value out of a value obtained by subtracting a first duty from 100 percent, and a value of a second duty out of the first duty and the second duty, the first duty being a duty for approximating the voltage value of the first conductive path to a voltage target value of the first conductive path, and the second duty being a duty for approximating the voltage value of the second conductive path to a voltage target value of the second conductive path; (2) define a second candidate duty for limiting a current value in a first current direction, based on at least a current target value in the first current direction in one of the first conductive path and the second conductive path and the current value of the one of the conductive paths; (3) define a third candidate duty for limiting a current value in a second current direction opposite to the first current direction, based on at least a current target value in the second current direction in the one of the conductive paths and the current value of the one of the conductive paths; (4) determine the usage duty based on the minimum value of candidates that include the first candidate duty and the second candidate duty if the direction of current flowing through at least one of the first conductive path and the second conductive path is the first current direction; and (5) determine the usage duty based on the maximum value of candidates that include the first candidate duty and the third candidate duty if the direction of current flowing through at least one of the first conductive path and the second conductive path is the second current direction.

### Advantageous Effects of Disclosure

A voltage conversion device according to the present disclosure can limit excessive current regardless of the direction in which current flows, while realizing the function of shortening the time it takes to switch between the step-down operation and the step-up operation.

### BRIEF DESCRIPTION OF DRAWINGS

FIG. 1 is a circuit diagram schematically illustrating an onboard power system that includes a voltage conversion device according to Embodiment 1 of this disclosure.

FIG. 2 is a diagram illustrating the relationship between a first voltage value, a second voltage value, a first current value, a second current value, a first power value, a second power value, and a current direction in the voltage conversion device according to Embodiment 1.

FIG. 3 is a diagram schematically illustrating specific content of a control unit and specific content of a drive unit in the voltage conversion device according to Embodiment 1.

FIG. 4 is a functional block diagram schematically showing specific content of a duty computation unit in the control unit shown in FIG. 3.

FIG. 5 is a functional block diagram schematically showing some functions of a portion of the duty computation unit that determines a first candidate duty.

FIG. 6 is a functional block diagram schematically showing the function of a portion of the duty computation unit that determines second and third candidate duties.

FIG. 7 is a functional block diagram schematically showing the function of the portion of the duty computation unit that determines fourth and fifth candidate duties.

### DETAILED DESCRIPTION OF PREFERRED EMBODIMENTS

The following enumerates and describes embodiments of this disclosure. Note that the features (1) to (7) described below may be combined as long as there are no inconsistencies.

### Feature (1)

A voltage conversion device includes a voltage conversion unit that includes a high-side switch, a low-side switch, and an inductor, and that is configured to perform voltage conversion between a first conductive path and a second conductive path; a first voltage value detection unit configured to detect a first voltage value that is a voltage value of the first conductive path; a first current value detection unit configured to detect a first current value that is a value of current flowing through the first conductive path; a second voltage value detection unit configured to detect a second voltage value that is a voltage value of the second conductive path; a second current value detection unit configured to detect a second current value that is a value of current flowing through the second conductive path; a determination unit configured to determine a usage duty based on the first voltage value, the second voltage value, the first current value, and the second current value; and a drive unit configured to input a first control signal that is based on the usage duty determined by the determination unit to the high-side switch, and to input a second control signal that is based on a signal obtained by inverting the first control signal to the low-side switch, in which the voltage conversion unit is configured to perform at least a step-down operation for stepping down a voltage applied to the first conductive path through an on/off operation of the high-side switch and applying an output voltage to the second conductive path, and a step-up operation for stepping up a voltage applied to the second conductive path through an on/off operation of the low-side switch and applying an output voltage to the first conductive path, and the determination unit is configured to define a first candidate duty based on a larger value or a smaller value out of a value obtained by subtracting a first duty from 100 percent, and a value of a second duty out of the first duty and the second duty the first duty being a duty for approximating the voltage value of the first conductive path to a voltage target value of the first conductive path, and the second duty being a duty for approximating the voltage value of the second conductive path to a voltage target value of the second conductive path, define a second candidate duty for limiting a current value in a first current direction from the first conductive path to the second conductive path, based on at least a current target value in the first current direction in one of the first conductive path and the second conductive path and a current value of the one of the conductive paths, define a third candidate duty for limiting a current value in a second current direction opposite to the first current direction, based on at least a current target value in the second current direction in the one of the conductive paths and the current value of the one of the conductive paths, determine the usage duty based on the minimum value of candidates that include the first candidate duty and the second candidate duty if the direction of current flowing through at least one of the first conductive path and the second conductive path is the first current direction, and determine the usage duty based on the maximum value of candidates that include the first candidate duty and the third candidate duty if the direction of current flowing through at least one of the first conductive path and the second conductive path is the second current direction.

In the voltage conversion device according to feature (1) above, the first duty is a duty for approximating the voltage value of the first conductive path to the voltage target value of the first conductive path, and the second duty is a duty for approximating the voltage value of the second conductive path to the voltage target value of the second conductive path. Also, the determination unit defines the first candidate duty based on the larger value or the smaller value out of the value of the second duty out of the first duty and the second duty and the value obtained by subtracting the first duty from 100 percent. The first duty is a duty for a step-up operation, and the second duty is a duty for a step-down operation. That is, if the first candidate duty is used as the usage duty the voltage conversion device can always select one of the duty for a step-down operation and the duty for a step-up operation and perform a step-down operation or a step-up operation while maintaining an environment where both the duty for the step-down operation and the duty for the step-up operation can be determined. Also, based on the relationship between the first duty and the second duty the voltage conversion device can quickly switch whether to give priority to the step-down operation or the step-up operation when determining the first candidate duty. When one of the step-down operation and the step-up operation is being performed, if the duty balance changes to a state where priority is to be given to the other operation, the voltage conversion device can update the first candidate duty so as to give priority to the other duty immediately, for example.

If the voltage conversion device according to feature (1) above operates using the first candidate duty as the usage duty in this manner, the voltage conversion device can smoothly switch between the step-down operation and the step-up operation based on the balance between the first duty and the second duty. However, under a predetermined condition, the voltage conversion device can impose a limitation so as to give priority to the other candidate duty over the first candidate duty when determining the usage duty. Specifically the voltage conversion device regards a direction from the first conductive path to the second conductive path as the first current direction, and regards the current direction opposite to the first current direction as the second current direction. Also, the voltage conversion device defines the second candidate duty for limiting the current value in the first current direction based on at least the current target value in the first current direction in “one” of the first conductive path and the second conductive path and the current value of the “one” of the conductive paths. Then, the voltage conversion device determines the usage duty based on the minimum value of candidates that include the first candidate duty and the second candidate duty if the direction of current flowing through at least one of the first conductive path and the second conductive path is the first current direction. That is, if the second candidate duty is smaller than the first candidate duty when current flows in the first current direction, the voltage conversion device gives priority to the second candidate duty having a relatively small duty Thus, in this case, the voltage conversion device can further limit the current in the first current direction, than in a case where at least the first candidate duty is used as the usage duty. Also, the voltage conversion device defines the third candidate duty for limiting the current value in the second current direction based on at least the current target value in the second current direction in the “one” of the conductive paths and the current value of the “one” of the conductive paths. Then, the voltage conversion device determines the usage duty based on the maximum value of candidates that include the first candidate duty and the third candidate duty if the direction of current flowing through at least one of the first conductive path and the second conductive path is the second current direction. That is, if the third candidate duty is larger than the first candidate duty when current flows in the second current direction, the voltage conversion device gives priority to the third candidate duty having a relatively large duty. When current is flowing in the second current direction, if priority is given to the first candidate duty and the usage duty decreases, the current further increases in the second current direction. However, the voltage conversion device can suppress such a current increase. That is, the voltage conversion device can increase the usage duty by giving priority to the third candidate duty in the above-described case, and impose a limitation so as to approximate the current value in the second current direction to the current target value in the second current direction.

### Feature (2)

The voltage conversion device according to feature (1), in which the voltage conversion unit includes a full bridge circuit provided with the high-side switch, the low-side switch, the inductor, a second high-side switch, and a second low-side switch, the voltage conversion unit is configured to switch between a first voltage conversion state where at least the step-down operation that is based on the on/off operation of the high-side switch and the step-up operation that is based on the on/off operation of the low-side switch are performed, and a second voltage conversion state where at least a second step-down operation for stepping down the voltage applied to the second conductive path through an on/off operation of the second high-side switch and applying an output voltage to the first conductive path and a second step-up operation for stepping up the voltage applied to the first conductive path through an on/off operation of the second low-side switch and applying an output voltage to the second conductive path are performed, and the drive unit is configured to input the first control signal to the high-side switch and to input the second control signal to the low-side switch in the first voltage conversion state, and to input a fourth control signal that is based on the usage duty determined by the determination unit to the second low-side switch and to input a third control signal that is based on a signal obtained by inverting the fourth control signal to the second high-side switch in the second voltage conversion state.

The voltage conversion device according to feature (2) above can perform bidirectional voltage conversion using the full bridge circuit. Furthermore, if the voltage conversion device operates using the first candidate duty as the usage duty not only in the first voltage conversion state but also in the second voltage conversion state, the voltage conversion device can smoothly switch between the step-down operation and the step-up operation based on the balance between the first duty and the second duty. Also, under a predetermined condition, the voltage conversion device can impose a limitation so as to give priority to the other candidate duty over the first candidate duty when determining the usage duty in the second voltage conversion state as well. Specifically if the second candidate duty is smaller than the first candidate duty when current flows in the first current direction, the voltage conversion device gives priority to the second candidate duty having a relatively small duty in the second voltage conversion state as well. Thus, in this case, the voltage conversion device can further limit the current in the first current direction, than in a case where at least the first candidate duty is used as the usage duty. Also, if the third candidate duty is larger than the first candidate duty when current flows in the second current direction, the voltage conversion device gives priority to the third candidate duty having a relatively large duty in the second voltage conversion state as well. Thus, the voltage conversion device can increase the usage duty by giving priority to the third candidate duty and impose a limitation so as to approximate the current value in the second current direction to the current target value in the second current direction.

### Feature (3)

A voltage conversion device includes: a voltage conversion unit that includes a high-side switch, a low-side switch, and an inductor, and that is configured to perform voltage conversion between a first conductive path and a second conductive path; a first voltage value detection unit configured to detect a first voltage value that is a voltage value of the first conductive path; a first current value detection unit configured to detect a first current value that is a value of current flowing through the first conductive path; a second voltage value detection unit configured to detect a second voltage value that is a voltage value of the second conductive path; a second current value detection unit configured to detect a second current value that is a value of current flowing through the second conductive path; a determination unit configured to determine a usage duty based on the first voltage value, the second voltage value, the first current value, and the second current value; and a drive unit configured to input a PWM control signal that is based on the usage duty determined by the determination unit to the low-side switch, and to input an inverted control signal that is based on a signal obtained by inverting the PWM control signal to the high-side switch, in which the voltage conversion unit is configured to perform at least a step-down operation for stepping down a voltage applied to the second conductive path through an on/off operation of the high-side switch and applying an output voltage to the first conductive path, and a step-up operation for stepping up a voltage applied to the first conductive path through an on/off operation of the low-side switch and applying an output voltage to the second conductive path, and the determination unit is configured to define a first candidate duty based on a larger value or a smaller value out of a value obtained by subtracting a first duty from 100 percent, and a value of a second duty out of the first duty and the second duty, the first duty being a duty for approximating the voltage value of the first conductive path to a voltage target value of the first conductive path, and the second duty being a duty for approximating the voltage value of the second conductive path to a voltage target value of the second conductive path, define a second candidate duty for limiting a current value in a first current direction, based on at least a current target value in the first current direction in one of the first conductive path and the second conductive path and a current value of the one of the conductive paths, define a third candidate duty for limiting a current value in a second current direction opposite to the first current direction, based on at least a current target value in the second current direction in the one of the conductive paths and the current value of the one of the conductive paths, determine the usage duty based on the minimum value of candidates that include the first candidate duty and the second candidate duty if the direction of current flowing through at least one of the first conductive path and the second conductive path is the first current direction, and determine the usage duty based on the maximum value of candidates that include the first candidate duty and the third candidate duty if the direction of current flowing through at least one of the first conductive path and the second conductive path is the second current direction.

Based on the same concept as in feature (1) above, the voltage conversion device according to feature (3) can limit excessive current regardless of the direction in which current flows, while realizing the function of shortening the time it takes to switch between the step-down operation and the step-up operation.

### Feature 4

The voltage conversion device according to any one of features (1) to (3), in which the determination unit is configured to define the second candidate duty based on a smaller deviation out of a first current deviation and a second current deviation, and to define the third candidate duty based on a larger deviation out of a third current deviation and a fourth current deviation, the first current deviation is a deviation obtained by subtracting the current value of the one of the conductive paths from the current target value in the first current direction in the one of the conductive paths, the second current deviation is a deviation obtained by subtracting a current value of the other conductive path that is different from the one of the first conductive path and the second conductive path, from the current target value in the first current direction in the other conductive path, the third current deviation is a deviation obtained by subtracting the current value of the one of the conductive paths from the current target value in the second current direction in the one of the conductive paths, and the fourth current deviation is a deviation obtained by subtracting the current value of the other conductive path from the current target value in the second current direction in the other conductive path.

The voltage conversion device according to feature (4) above is configured to define the second candidate duty based on the smaller deviation out of the first current deviation and the second current deviation. Therefore, the voltage conversion device can define the second candidate duty that can further limit the current in the first current direction, based on the condition of the one of the two conductive paths where the current in the first current direction is to be further suppressed. Also, the voltage conversion device defines the third candidate duty based on the larger deviation out of the third current deviation and the fourth current deviation. Therefore, the voltage conversion device can define the third candidate duty that can further limit the current in the second current direction, based on the conditions of the two conductive paths.

### Feature (5)

The voltage conversion device according to any one of features (1) to (4), in which the determination unit is configured to define a fourth candidate duty for limiting power in the first current direction based on at least a power target value in the first current direction in the one of the conductive paths and a power value of the one of the conductive paths, define a fifth candidate duty for limiting power in the second current direction based on at least a power target value in the second current direction in the one of the conductive paths and the power value of the one of the conductive paths, determine the usage duty based on the minimum value of candidates that include the first candidate duty the second candidate duty, and the fourth candidate duty if the direction of current flowing through at least one of the first conductive path and the second conductive path is the first current direction, and determine the usage duty based on the maximum value of candidates that include the first candidate duty the third candidate duty and the fifth candidate duty if the direction of current flowing through at least one of the first conductive path and the second conductive path is the second current direction.

The voltage conversion device according to feature (5) above defines the fourth candidate duty for limiting a power value in the first current direction based on at least the power target value in the first current direction in the “one” of the conductive paths and the power value of the “one” of the conductive paths. Also, if the fourth candidate duty is smaller than the first candidate duty and the second candidate duty when current flows in the first current direction, the voltage conversion device gives priority to the fourth candidate duty having a relatively small duty. In this case, the voltage conversion device can further limit the power in the first current direction, than in a case where at least the first candidate duty or the second candidate duty is used as the usage duty. Also, the voltage conversion device defines the fifth candidate duty for limiting the power value in the second current direction based on at least the power target value in the second current direction in the “one” of the conductive paths and the power value of the “one” of the conductive paths. Then, if the fifth candidate duty is larger than the first candidate duty or the third candidate duty when current flows in the second current direction, the voltage conversion device gives priority to the fifth candidate duty having a relatively large duty. When current is flowing in the second current direction, if priority is given to the first candidate duty or the third candidate duty and the usage duty decreases, the power further increases in the second current direction. However, the voltage conversion device can suppress such a power increase. That is, the voltage conversion device can increase the usage duty by giving priority to the fifth candidate duty in the above-described case, and impose a limitation so as to approximate the power value in the second current direction to the power target value in the second current direction.

### Feature (6)

The voltage conversion device according to feature (5), in which the determination unit is configured to define the fourth candidate duty based on a smaller deviation out of a first power deviation and a second power deviation, and to define the fifth candidate duty based on a larger deviation out of a third power deviation and a fourth power deviation, the first power deviation is a deviation obtained by subtracting the power value of the one of the conductive paths from the power target value in the first current direction in the one of the conductive paths, the second power deviation is a deviation obtained by subtracting a power value of the other conductive path that is different from the one of the first conductive path and the second conductive path, from a power target value of the other conductive path, the third power deviation is a deviation obtained by subtracting the power value of the one of the conductive paths from the power target value in the second current direction in the one of the conductive paths, and the fourth power deviation is a deviation obtained by subtracting the power value of the other conductive path from a power target value in the second current direction in the other conductive path.

The voltage conversion device according to feature (6) above is configured to define the fourth candidate duty based on the smaller deviation out of the first power deviation and the second power deviation. Therefore, the voltage conversion device can define the fourth candidate duty that can further limit the power in the first current direction, based on the condition of the one of the two conductive paths where the power in the first current direction is to be further suppressed. Also, the voltage conversion device defines the fifth candidate duty based on the larger deviation out of the third power deviation and the fourth power deviation. Therefore, the voltage conversion device can define the fifth candidate duty that can further limit the power in the second current direction, based on the conditions of the two conductive paths.

### Feature (7)

The voltage conversion device according to any one of features (1) to (6), in which the determination unit includes a switching unit configured to switch whether to define the first candidate duty based on the larger value or the smaller value.

The voltage conversion device according to feature (7) above can select whether to give priority to the step-down operation or the step-up operation in the case of conflict.

### Embodiment 1

Hereinafter, Embodiment 1 that embodies the disclosure will be described.

### Basic Configuration of Power System

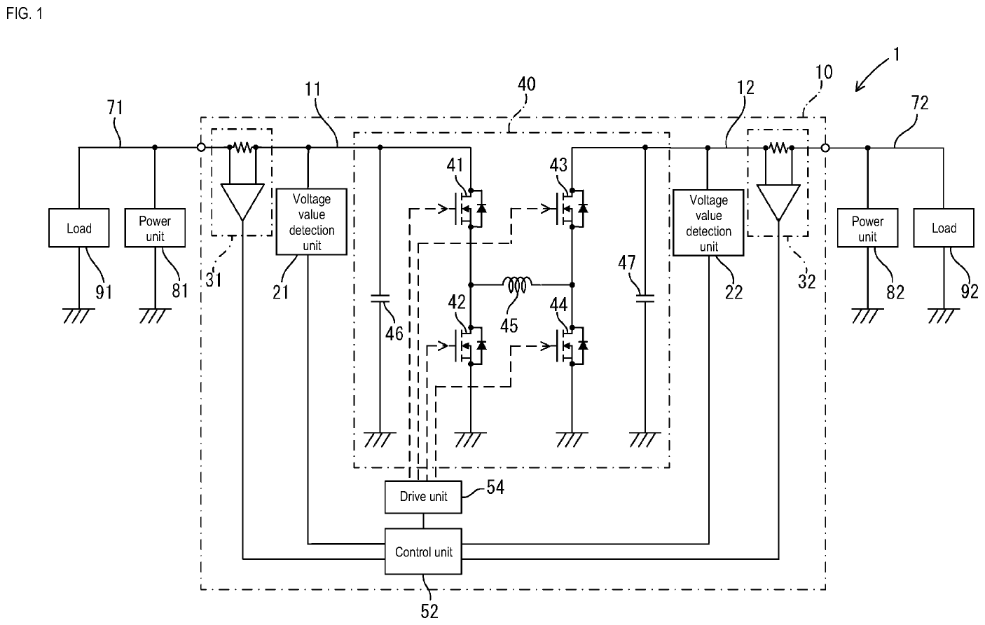

A power system 1 shown in FIG. 1 is constituted as an onboard power system to be mounted in a vehicle or the like, for example. The power system 1 has a configuration provided with a power unit 81, a power unit 82, and a voltage conversion device 10. The power system 1 is constituted as a system that can supply power to a load 91 and a load 92 with the power unit 81 or the power unit 82 as the power supply source.

The power unit 81 is constituted as an onboard power storage unit such as an electric double-layer capacitor, a lithium-ion battery or a lead storage battery for example. The power unit 81 has a terminal on the high potential side that is electrically connected to a line 71 and a terminal on the low potential side that is electrically connected to ground. The power unit 81 applies a predetermined output voltage to the line 71. Note that, in this description, “voltage” means the potential difference to ground, unless specifically stated otherwise.

The power unit 82 is constituted as an onboard power storage unit such as an electric double-layer capacitor, a lithium-ion battery or a lead storage battery for example. The power unit 82 has a terminal on the high potential side that is electrically connected to a line 72 and a terminal on the low potential side that is electrically connected to ground, and applies a predetermined output voltage to the line 72. The output voltage that the power unit 82 applies to the line 72 may be larger or smaller than the output voltage that the power unit 81 applies to the line 71. The following describes a configuration in which the output voltage of the power unit 81 is larger than the output voltage of the power unit 82.

The load 92 is an onboard load such as a starter, a wiper, an audio system, a shift-by-wire system, or an electronic parking brake, for example. The load 92 is electrically connected to the line 72, and can operate with power that is supplied from the power unit 82. Also, the load 92 can receive power that is supplied from the power unit 81 via the voltage conversion device 10. The load 91 is an onboard load such as a heater, for example. The load 91 is electrically connected to the line 71, and can operate with power that is supplied from the power unit 81. Also, the load 91 can receive power that is supplied from the power unit 82 via a voltage conversion unit 40.

The line 71 is electrically connected to the conductive path 11 so as to have a comparable potential to the potential of one end of the conductive path 11. The line 72 is electrically connected to the conductive path 12 so as to have a comparable potential to the potential of one end of the conductive path 12.

The voltage conversion device 10 includes the voltage conversion unit 40, a voltage value detection unit 21, a voltage value detection unit 22, a current value detection unit 31, a current value detection unit 32, a capacitor 46, a capacitor 47, a control unit 52, a drive unit 54, and the like.

The voltage conversion unit 40 is provided between the conductive path 11 and the conductive path 12, and performs voltage conversion between the conductive path 11 and the conductive path 12. The voltage conversion unit 40 is a circuit that performs voltage conversion with one of the line 71 and the line 72 as the input side and the other thereof as the output side. The voltage conversion unit 40 is provided with a switch 41, a switch 42, a switch 43, a switch 44, and an inductor 45, and is constituted as a full bridge circuit. The switches 41, 42, 43, and 44 are constituted by semiconductor switches. The switches 41, 42, 43, and 44 are constituted as N-channel MOSFETs, for example. The switch 41 and the switch 42 are connected in series between the conductive path 11 and ground. The switch 43 and the switch 44 are connected in series between the conductive path 12 and ground. The voltage conversion unit 40 is a so-called H-bridge circuit in which one end of the inductor 45 is electrically connected to the connection point between the switch 41 and the switch 42, and the other end of the inductor 45 is electrically connected to the connection point between the switch 43 and the switch 44. The conductive path 11 is electrically connected to the drain of the switch 41, and the voltage of the conductive path 11 is applied to the drain of the switch 41. The drain of the switch 42 and one end of the inductor 45 are electrically connected to the source of the switch 41. The drain of the switch 42 is electrically connected to the connection point between the switch 41 and the inductor 45. The source of the switch 42 is electrically connected to ground, and the ground voltage (e.g., 0 V) is applied thereto. The conductive path 12 is electrically connected to the drain of the switch 43, and the voltage of the conductive path 12 is applied to the drain. The drain of the switch 44 and the other end of the inductor 45 are electrically connected to the source of the switch 43. The drain of the switch 44 is electrically connected to the connection point between the switch 43 and the inductor 45. The source of the switch 44 is electrically connected to ground, and the ground voltage (e.g., 0 V) is applied thereto.

The voltage conversion unit 40 switches between a first voltage conversion state and a second voltage conversion state. The first voltage conversion state is the state where at least a first step-down operation that is based on the on/off operation of the switch 41 (high-side switch) and a first step-up operation that is based on the on/off operation of the switch 42 (low-side switch) are performed. The voltage conversion unit 40 performs the first step-down operation so as to step down the voltage that is applied to the conductive path 11 and apply an output voltage to the conductive path 12. The voltage conversion unit 40 performs the first step-up operation so as to step up the voltage that is applied to the conductive path 12 and apply an output voltage to the conductive path 11. The second voltage conversion state is the state where at least a second step-down operation and a second step-up operation are performed respectively through the on/off operation of the switch 43 (second high-side switch) and the on/off operation of the switch 44 (second low-side switch). The voltage conversion unit 40 performs the second step-down operation so as to step down the voltage that is applied to the conductive path 12 and apply an output voltage to the conductive path 11. The voltage conversion unit 40 performs the second step-up operation so as to step up the voltage that is applied to the conductive path 11 and apply an output voltage to the conductive path 12.

One end of the capacitor 46 is electrically connected to the conductive path 11, and the other end is electrically connected to ground. One end of the capacitor 47 is electrically connected to the conductive path 12, and the other end is electrically connected to ground.

Both the voltage value detection unit 21 and the voltage value detection unit 22 are constituted as known voltage detection circuits. The voltage value detection unit 21 detects the voltage value of the conductive path 11. The voltage value detection unit 21 outputs an analog voltage indicating the detected voltage value to the control unit 52. The voltage value detection unit 22 detects the voltage value of the conductive path 12. The voltage value detection unit 22 outputs an analog voltage indicating the detected voltage value to the control unit 52.

Both the current value detection unit 31 and the current value detection unit 32 are constituted as known current detection circuits. The current value detection unit 31 detects the value of current flowing through the conductive path 11. The current value detection unit 32 detects the value of current flowing through the conductive path 12.

The control unit 52 is constituted as an MCU (Micro Controller Unit), for example, and is constituted to be provided with a computational processing unit consisting of a CPU (Central Processing Unit) or the like and a storage unit consisting of a ROM (Read Only Memory), a RAM (Random Access Memory) or the like. The control unit 52 operates to generate a PWM signal based on the voltage value of the conduction path 11 detected by the voltage value detection unit 21 and the voltage value of the conduction path 12 detected by the voltage value detection unit 22, and output the PWM signal to the drive unit 54.

The drive unit 54 inputs a first control signal to the switch 41 (high-side switch) and inputs a second control signal to the switch 42 (low-side switch) in the first voltage conversion state. The drive unit 54 inputs a fourth control signal to the switch 44 (second low-side switch) and inputs a third control signal to the switch 43 (second high-side switch) in the second voltage conversion state. The first control signal is a PWM signal that is based on the usage duty determined by the determination unit in the first voltage conversion state. The second control signal is an ON/OFF signal that is based on a signal obtained by inverting the first control signal. The fourth control signal is a PWM signal that is based on the usage duty determined by the determination unit in the second voltage conversion state. The third control signal is an ON/OFF signal that is based on a signal obtained by inverting the fourth control signal.

### Detailed Configuration of Voltage Conversion Device

In the voltage conversion device 10 according to Embodiment 1, the conductive path 11 corresponds to an example of the first conductive path. The conductive path 12 corresponds to an example of the second conductive path. The switch 41 corresponds to an example of the high-side switch. The switch 42 corresponds to an example of the low-side switch. The switch 43 corresponds to an example of the second high-side switch. The switch 44 corresponds to an example of the second low-side switch. The voltage value detection unit 21 corresponds to an example of the first voltage value detection unit. The voltage value detection unit 22 corresponds to an example of the second voltage value detection unit. The current value detection unit 31 corresponds to an example of the first current value detection unit. The current value detection unit 32 corresponds to an example of the second current value detection unit. The control unit 52 corresponds to an example of the determination unit, and determines the usage duty based on the first voltage value, the second voltage value, the first current value, the second current value, the first power value, and the second power value.

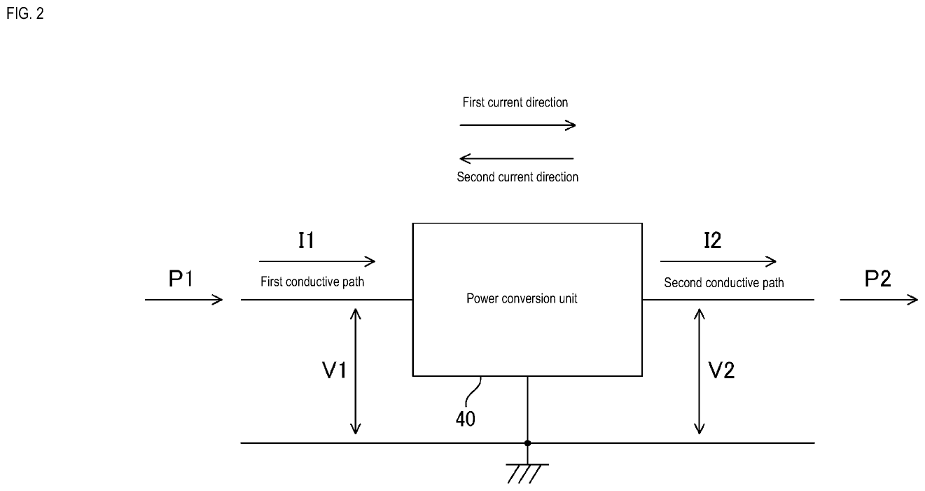

FIG. 2 is a diagram illustrating the relationship between a first voltage value V1, a second voltage value V2, a first current value I1, a second current value I2, a first power value P1, a second power value P2, a first current direction, and a second current direction in the voltage conversion device 10.

In Embodiment 1, the conductive path 11 is the first conductive path, and thus the voltage value detection unit 21 detects the first voltage value V1, which is the voltage value of the first conductive path. Also, the conductive path 12 is the second conductive path, and thus the voltage value detection unit 22 detects the second voltage value V2, which is the voltage value of the second conductive path. The current value detection unit 31 detects the first current value I1, which is the value of current flowing through the first conductive path. The current value detection unit 32 detects the second current value I2, which is the value of current flowing through the second conductive path. With regard to both the first current value I1 and the second current value I2, the direction of current flowing from the first conductive path (conductive path 11) to the second conductive path (conductive path 12) is the positive direction, and the direction of current flowing from the second conductive path (conductive path 12) to the first conductive path (conductive path 11) is the negative direction. The direction of current flowing from the first conductive path (conductive path 11) to the second conductive path (conductive path 12) is the first current direction. The direction of current flowing from the second conductive path (conductive path 12) to the first conductive path (conductive path 11) is the second current direction.

With regard to power, the power when current flows in the first current direction is the positive power, and the power when current flows in the second current direction is the negative power. The power value P1 of the first conductive path (conductive path 11) is obtained through P1=V1×I1. Because V1>0 holds true, the power value P1 is a positive value when current flows in the first current direction in the first conductive path (conductive path 11) (when I1 has a positive value). The power value P1 is a negative value when current flows in the second current direction in the first conductive path (conductive path 11) (when I1 has a negative value). The power value P2 of the second conductive path (conductive path 12) is obtained through P2=V2×I2. Because V2>0 holds true, the power value P2 is a positive value when current flows in the first current direction in the second conductive path (conductive path 12) (when I2 has a positive value). The power value P2 is a negative value when current flows in the second current direction in the second conductive path (conductive path 12) (when I2 has a negative value).

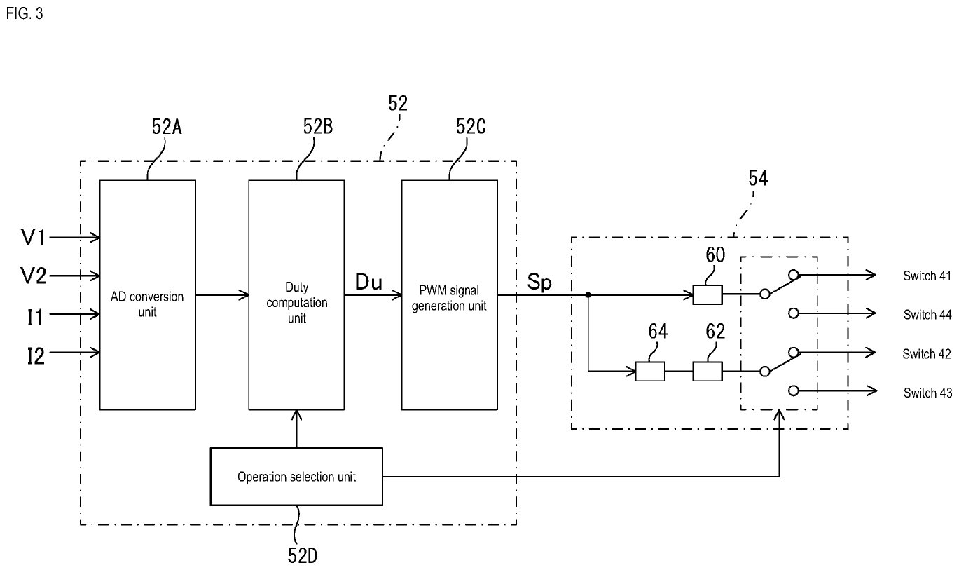

FIG. 3 is a diagram showing the control unit 52 and the drive unit 54, and showing the functions of the control unit 52 as blocks.

An AD conversion unit 52A functions to convert various types of analog data into digital data. The AD conversion unit 52A can convert detected values (analog values) received from the voltage value detection units 21 and 22 and the current value detection units 31 and 32 into digital values.

A duty computation unit 52B functions to determine a usage duty Du based on the first voltage value V1, the second voltage value V2, the first current value I1, the second current value I2, the first power value P1, and the second power value P2. A method for generating the usage duty Du by the duty computation unit 52B will be described later.

A PWM signal generation unit 52C functions to generate a PWM signal Sp whose duty is set to the usage duty Du determined by the duty computation unit 52B, and output the PWM signal Sp to the drive unit 54.

An operation selection unit 52D functions to select whether the voltage conversion unit 40 is in the first voltage conversion state or the second voltage conversion state according to an instruction received from an external device such as an external ECU or the like. If an external device provides a first instruction for giving an instruction to switch to the first voltage conversion state to the control unit 52, the operation selection unit 52D provides a signal or information indicating that the voltage conversion unit 40 is in the first voltage conversion state to the duty computation unit 52B and the drive unit 54. If an external device provides a second instruction for giving an instruction to switch to the second voltage conversion state to the control unit 52, the operation selection unit 52D provides a signal or information indicating that the voltage conversion unit 40 is in the second voltage conversion state to the duty computation unit 52B and the drive unit 54.

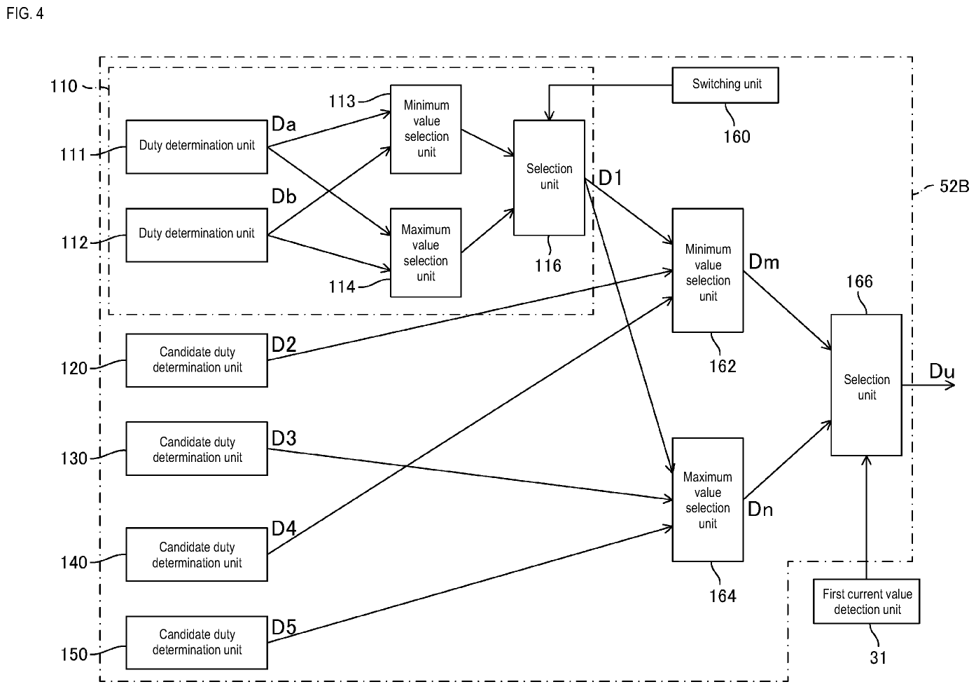

As shown in FIG. 4, the duty computation unit 52B includes candidate duty determination units 110, 120, 130, 140, and 150. Furthermore, the duty computation unit 52B includes a minimum value selection unit 162, a maximum value selection unit 164, a selection unit 166, and a switching unit 160.

The candidate duty determination unit 110 functions to determine the first candidate duty D1, and includes a duty determination unit 111, a duty determination unit 112, a minimum value selection unit 113, a maximum value selection unit 114, and a selection unit 116.

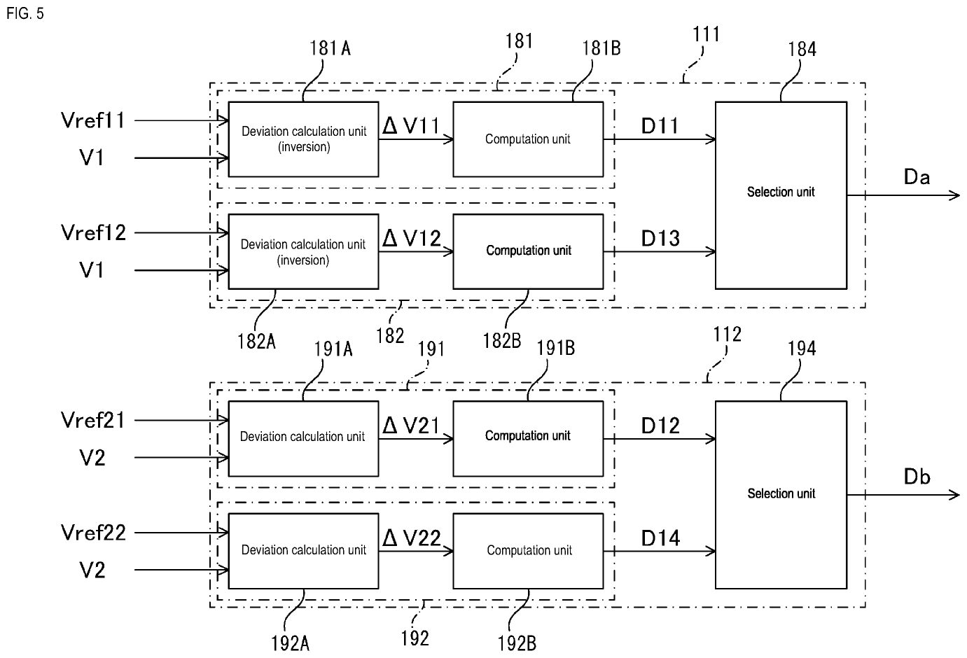

As shown in FIG. 5, the duty determination unit 111 includes a first generation unit 181, a second generation unit 182, and a selection unit 184. The first generation unit 181 includes a deviation calculation unit 181A and a computation unit 181B. The second generation unit 182 includes a deviation calculation unit 182A and a computation unit 182B.

The deviation calculation unit 181A calculates a value ΔV11, which is the value obtained by inverting the positive or negative sign of a value obtained by subtracting the first voltage value V1 of the first conductive path (conductive path 11) from a voltage target value Vref11 of the first conductive path (conductive path 11) for the first voltage conversion state. ΔV11 can be expressed by the equation ΔV11=V1−Vref11. The computation unit 181B calculates a duty D11 using a known feedback computation method (e.g., PI computation method, etc.) based on the deviation ΔV1l. The duty D11 is a duty obtained through the feedback computation based on the inverted deviation. The duty D11 corresponds to a value obtained by subtracting, from 100 percent, the duty (first duty) for approximating the voltage value of the first conductive path (conductive path 11) to the voltage target value Vref11 based on the first voltage value V1.

The deviation calculation unit 182A similarly calculates a value ΔV12, which is the value obtained by inverting a value that is obtained by subtracting the first voltage value V1 of the first conductive path (conductive path 11) from a voltage target value Vref12 of the first conductive path (conductive path 11) for the second voltage conversion state. ΔV12 can be expressed by the equation ΔV12=V1−Vref12. The computation unit 182B calculates a duty D13 using a known feedback computation method (e.g., PI computation method, etc.) based on the deviation ΔV12. The duty D13 is a duty obtained through the feedback computation based on the inverted deviation. The duty D13 corresponds to a value obtained by subtracting, from 100 percent, the duty (first duty) for approximating the voltage value of the first conductive path (conductive path 11) to the voltage target value Vref12 based on the first voltage value V1.

If the current state is the first voltage conversion state, the selection unit 184 selects the duty D11 generated by the first generation unit 181 to be one duty Da to be compared. Also, if the current state is the second voltage conversion state, the selection unit 184 selects the duty D13 generated by the second generation unit 182 to be the one duty Da to be compared.

As shown in FIG. 5, the duty determination unit 112 includes a first generation unit 191, a second generation unit 192, and a selection unit 194. The first generation unit 191 includes a deviation calculation unit 191A and a computation unit 191B. The second generation unit 192 includes a deviation calculation unit 192A and a computation unit 192B.

The deviation calculation unit 191A calculates a value ΔV21 by subtracting the second voltage value V2 of the second conductive path (conductive path 12) from a voltage target value Vref21 of the second conductive path for the first voltage conversion state. ΔV21 can be expressed by the equation ΔV21=Vref21−V2. The computation unit 191B calculates a duty D12 using a known feedback computation method (e.g., PI computation method, etc.) based on the deviation ΔV21 so as to approximate the voltage value of the second conductive path (conductive path 12) to the voltage target value Vref21.

The deviation calculation unit 192A similarly calculates a value ΔV22 by subtracting the second voltage value V2 of the second conductive path (conductive path 12) from a voltage target value Vref22 of the second conductive path for the second voltage conversion state. ΔV22 can be expressed by the equation ΔV22=Vref22−V2. The computation unit 192B calculates a duty D14 using a known feedback computation method (e.g., PI computation method, etc.) based on the deviation ΔV22 so as to approximate the voltage value of the second conductive path (conductive path 12) to the voltage target value Vref22.

If the current state is the first voltage conversion state, the selection unit 194 selects the duty D12 generated by the first generation unit 191 to be the other duty Db to be compared. Also, if the current state is the second voltage conversion state, the selection unit 194 selects the duty D14 generated by the second generation unit 192 to be the other duty Db to be compared.

The minimum value selection unit 113 shown in FIG. 4 selects the minimum value (a smaller value) out of the duty Da determined by the duty determination unit 111 and the duty Db determined by the duty determination unit 112. The maximum value selection unit 114 selects the maximum value (a larger value) out of the duty Da determined by the duty determination unit 111 and the duty Db determined by the duty determination unit 112.

The selection unit 116 selects a value that the switching unit 160 instructs the selection unit 116 to select, out of the minimum value selected by the minimum value selection unit 113 and the maximum value selected by the maximum value selection unit 114. Whether the selection unit 116 selects the maximum value (the larger value) or the minimum value (the smaller value) is determined by an instruction from the switching unit 160. The switching unit 160 outputs a first signal in the case of instructing selection of the maximum value (the larger value), and outputs a second signal in the case of instructing selection of the minimum value (the smaller value), for example. In this case, if the first signal is being output by the switching unit 160, the selection unit 116 selects the value (the larger value) selected by the maximum value selection unit 114. Also, if the second signal is being output by the switching unit 160, the selection unit 116 selects the value (the smaller value) selected by the minimum value selection unit 113. Note that the instruction method used by the switching unit 160 is not limited to the above example, and may be an instruction method that involves storing flag information in the case of instructing selection of the maximum value (the larger value), and not storing flag information in the case of instructing selection of the minimum value (the smaller value), for example. Note that the setting performed by the switching unit 160 will be updated by an operation or information that is input from outside.

In this example, in the first voltage conversion state, the duty for approximating the voltage value of the first conductive path (conductive path 11) to the voltage target value Vref11 of the first conductive path in the first voltage conversion state is the first duty. The duty obtained if the computation unit 181B has performed computation based on the deviation between Vref11 and V1 (Vref11−V1) corresponds to the first duty. On the other hand, D11 is a duty obtained as a result of the computation unit 181B performing computation based on the value obtained by inverting the deviation between Vref11 and V1 (Vref11−V1), and D11 corresponds to the value obtained by subtracting the first duty from 100 percent. In the first conversion state, D11 becomes Da, and D12, which corresponds to the second duty, becomes db. Therefore, the control unit 52 defines the first candidate duty D1 based on the larger value or the smaller value out of the second duty value and a value obtained by subtracting the first duty from 100 percent. Note that, although an example of calculating the value (D11) obtained by subtracting the first duty from 100 percent is described, the “value obtained by subtracting the first duty from 100 percent” may be calculated using another method. The value (D11) may be obtained by calculating the first duty based on the deviation (Vref11−V1), and subtracting the calculated first duty from 100 percent, for example.

In this example, in the second voltage conversion state, the duty for approximating the voltage value of the first conductive path (conductive path 11) to the voltage target value Vref12 of the first conductive path in the second voltage conversion state is the first duty. The duty obtained if the computation unit 182B has performed computation based on the deviation between Vref12 and V1 (Vref12−V1) corresponds to the first duty. On the other hand, D13 is a duty obtained as a result of the computation unit 182B performing computation based on the value obtained by inverting the deviation between Vref12 and V1 (Vref12−V1), and D13 corresponds to the value obtained by subtracting the first duty from 100 percent. In the second voltage conversion state, D13 becomes Da, and D14, which corresponds to the second duty, becomes db. Therefore, the control unit 52 defines the first candidate duty D1 based on the larger value or the smaller value out of the second duty value and a value obtained by subtracting the first duty from 100 percent. Note that, although an example of calculating the value (D13) obtained by subtracting the first duty from 100 percent is described, the “value obtained by subtracting the first duty from 100 percent” may be calculated using another method. The value (D13) may be obtained by calculating the first duty based on the deviation (Vref12−V1), and subtracting the calculated first duty from 100 percent, for example.

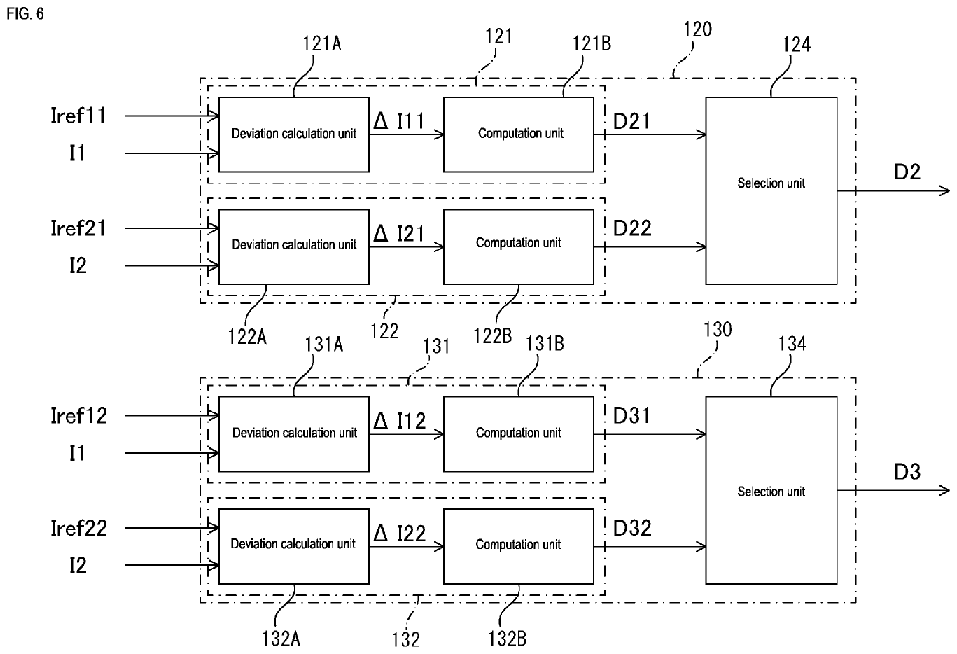

As shown in FIG. 6, the candidate duty determination unit 120 includes a first generation unit 121, a second generation unit 122, and a selection unit 124. The first generation unit 121 includes a deviation calculation unit 121A and a computation unit 121B. The second generation unit 122 includes a deviation calculation unit 122A and a computation unit 122B.

The deviation calculation unit 121A calculates a value ΔI11 by subtracting the first current value I1 of the first conductive path (conductive path 11) from a current target value Iref11 in the first current direction of the first conductive path (conductive path 11). ΔI11 can be expressed by the equation ΔI11=Iref11−I1. The computation unit 121B calculates a duty D21 using a known feedback computation method (e.g., PI computation method, etc.) based on the deviation ΔI11 so as to approximate the current value of the first conductive path (conductive path 11) to the current target value Iref11. The deviation calculation unit 122A similarly calculates a value ΔI21 by subtracting the second current value I2 of the second conductive path (conductive path 12) from a current target value Iref21 in the first current direction of the second conductive path (conductive path 12). ΔI21 can be expressed by the equation ΔI21=Iref21−I2. The computation unit 122B calculates a duty D22 using a known feedback computation method (e.g., PI computation method, etc.) based on the deviation ΔI21 so as to approximate the current value of the second conductive path (conductive path 12) to the current target value Iref21. The selection unit 124 selects the smaller duty out of the duty D21 generated by the first generation unit 121 and the duty D22 generated by the second generation unit 122 as the second candidate duty D2.

The control unit 52 corresponding to an example of the determination unit defines the second candidate duty D2 based on the smaller deviation out of ΔI11 (first current deviation) and ΔI21 (second current deviation) in this manner. The first current deviation ΔI11 is a deviation obtained by subtracting the current value I1 of the conductive path 11 (one of the conductive paths) from the current target value Iref11 in the first current direction in the conductive path 11 (one of the conductive paths). The second current deviation ΔI21 is a deviation obtained by subtracting the current value I2 of the conductive path 12 (the other conductive path) from the current target value Iref21 in the first current direction in the conductive path 12 (the other conductive path).

As shown in FIG. 6, the candidate duty determination unit 130 includes a first generation unit 131, a second generation unit 132, and a selection unit 134. The first generation unit 131 includes a deviation calculation unit 131A and a computation unit 131B. The second generation unit 132 includes a deviation calculation unit 132A and a computation unit 132B.

The deviation calculation unit 131A calculates a value ΔI12 by subtracting the first current value I1 of the first conductive path (conductive path 11) from the current target value Iref12 in the second current direction of the first conductive path (conductive path 11). ΔI12 can be expressed by the equation ΔI12=Iref12−I1. The computation unit 121B calculates a duty D31 using a known feedback computation method (e.g., PI computation method, etc.) based on the deviation ΔI12 so as to approximate the current value of the first conductive path (conductive path 11) to the current target value Iref12. The deviation calculation unit 132A similarly calculates a value ΔI22 by subtracting the second current value I2 of the second conductive path (conductive path 12) from a current target value Iref22 in the second current direction of the second conductive path (conductive path 12). ΔI22 can be expressed by the equation ΔI22=Iref22−I2. The computation unit 132B calculates a duty D32 using a known feedback computation method (e.g., PI computation method, etc.) based on the deviation ΔI22 so as to approximate the current value of the second conductive path (conductive path 12) to the current target value Iref22. The selection unit 134 selects the larger duty out of the duty D31 generated by the first generation unit 131 and the duty D32 generated by the second generation unit 132 as the third candidate duty D3.

The control unit 52 corresponding to an example of the determination unit defines the third candidate duty D3 based on a larger deviation out of ΔI12 (third current deviation) and ΔI22 (fourth current deviation) in this manner. The third current deviation ΔI12 is a deviation obtained by subtracting the current value I1 of the conductive path 11 (one of the conductive paths) from the current target value Iref12 in the second current direction in the conductive path 11 (one of the conductive paths). The fourth current deviation ΔI22 is a deviation obtained by subtracting the current value I2 of the conductive path 12 (the other conductive path) from the current target value Iref22 in the second current direction in the conductive path 12 (the other conductive path).

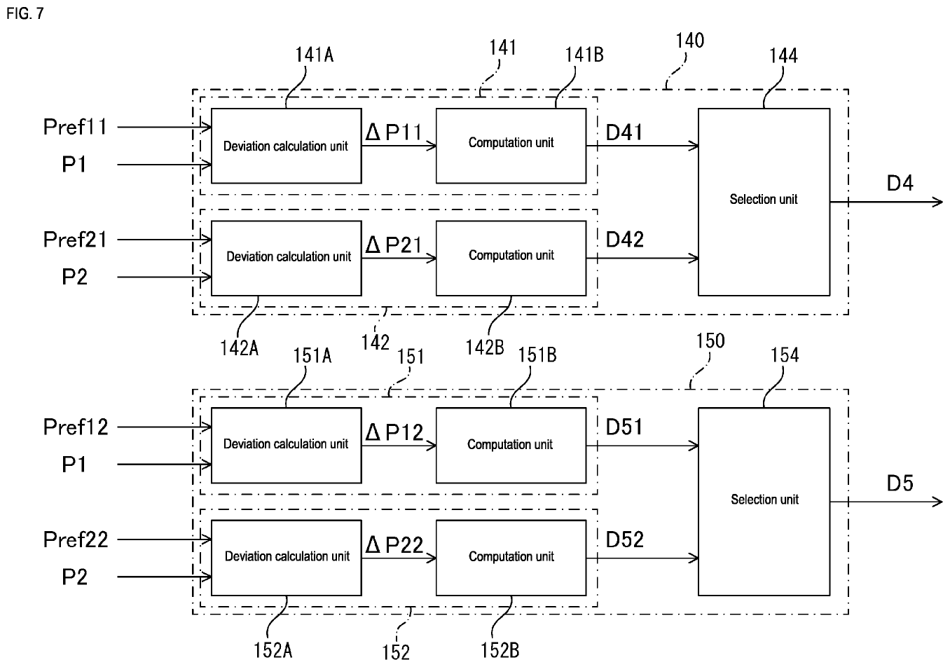

As shown in FIG. 7, the candidate duty determination unit 140 includes a first generation unit 141, a second generation unit 142, and a selection unit 144. The first generation unit 141 includes a deviation calculation unit 141A and a computation unit 141B. The second generation unit 142 includes a deviation calculation unit 142A and a computation unit 142B.

The deviation calculation unit 141A calculates a value ΔP11 by subtracting the first power value P1 of the first conductive path (conductive path 11) from the power target value Pref11 in the first current direction of the first conductive path (conductive path 11). ΔP11 can be expressed by the equation ΔP11=Pref11−P1. The computation unit 121B calculates a duty D41 using a known feedback computation method (e.g., PI computation method, etc.) based on the deviation ΔP11 so as to approximate the power value of the first conductive path (conductive path 11) to the power target value Pref11. The deviation calculation unit 142A similarly calculates a value ΔP21 by subtracting the second power value P2 of the second conductive path (conductive path 12) from the power target value Pref21 in the first current direction of the second conductive path (conductive path 12). ΔP21 can be expressed by the equation ΔP21=Pref21−P2. The computation unit 142B calculates a duty D42 using a known feedback computation method (e.g., PI computation method, etc.) based on the deviation ΔP21 so as to approximate the power value of the second conductive path (conductive path 12) to the power target value Pref21. The selection unit 144 selects, as the fourth candidate duty D4, the smaller duty out of the duty D41 generated by the first generation unit 141 and the duty D42 generated by the second generation unit 122.

The control unit 52 corresponding to an example of the determination unit defines the fourth candidate duty D4 based on the smaller deviation out of the first power deviation ΔP11 and the second power deviation ΔP21. The first power deviation ΔP11 is a deviation obtained by subtracting the power value P1 of the conductive path 11 (one of the conductive paths) from the power target value Pref11 in the first current direction in the conductive path 11 (one of the conductive paths). The second power deviation ΔP21 is a deviation obtained by subtracting the power value P2 of the conductive path 12 (the other conductive path) from the power target value Pref21 in the first current direction in the conductive path 12 (the other conductive path).

As shown in FIG. 7, the candidate duty determination unit 150 includes a first generation unit 151, a second generation unit 152, and a selection unit 154. The first generation unit 151 includes a deviation calculation unit 151A and a computation unit 151B. The second generation unit 152 includes a deviation calculation unit 152A and a computation unit 152B.

The deviation calculation unit 151A calculates a value ΔP12 by subtracting the first power value P1 of the first conductive path (conductive path 11) from the power target value Pref12 in the second current direction of the first conductive path (conductive path 11). ΔP12 can be expressed by the equation ΔP12=Pref12−P1. The computation unit 151B calculates a duty D51 using a known feedback computation method (e.g., PI computation method, etc.) based on the deviation ΔP12 so as to approximate the power value of the first conductive path (conductive path 11) to the power target value Pref12. The deviation calculation unit 152A similarly calculates a value ΔP22 by subtracting the second power value P2 of the second conductive path (conductive path 12) from the power target value Pref22 in the second current direction of the second conductive path (conductive path 12). ΔP22 can be expressed by the equation ΔP22=Pref22−P2. The computation unit 152B calculates a duty D52 using a known feedback computation method (e.g., PI computation method, etc.) based on the deviation ΔP22 so as to approximate the power value of the second conductive path (conductive path 12) to the power target value Pref22. The selection unit 154 selects, as the fifth candidate duty D5, the larger duty out of the duty D51 generated by the first generation unit 151 and the duty D52 generated by the second generation unit 152.

The control unit 52 corresponding to an example of the determination unit defines the fifth candidate duty D5 based on the larger deviation out of the third power deviation ΔP12 and the fourth power deviation ΔP22. The third power deviation ΔP12 is a deviation obtained by subtracting the power value P1 of the conductive path 11 (one of the conductive paths) from the power target value Pref12 in the second current direction in the conductive path 11 (one of the conductive paths). The fourth power deviation ΔP22 is a deviation obtained by subtracting the power value P2 of the conductive path 12 (the other conductive path) from the power target value Pref22 in the second current direction in the conductive path 12 (the other conductive path).

The voltage target values Vref11, Vref12, Vref21, and Vref22 are provided to the control unit 52 by an external device such as an external ECU. The current target values Iref11, Iref12, Iref21, and Iref22 are provided to the control unit 52 by an external device such as an external ECU. The power target values Pref11, Pref12, Pref21, and Pref22 are provided to the control unit 52 by an external device such as an external ECU. All of the target values are stored in the storage unit provided in the control unit 52.

The minimum value selection unit 162 shown in FIG. 4 selects the minimum value from among the first candidate duty D1, the second candidate duty D2, and the fourth candidate duty D4.

The maximum value selection unit 164 selects the maximum value from among the first candidate duty D1, the third candidate duty D3, and the fifth candidate duty D5.

The selection unit 166 shown in FIG. 4 selects, as the usage duty Du, either the minimum value Dm selected by the minimum value selection unit 162 or the maximum value Dn selected by the maximum value selection unit 164. If the direction of current flowing through the conductive path 11 is the first current direction, the selection unit 166 determines the minimum value Dm out of the first candidate duty D1, the second candidate duty D2, and the fourth candidate duty D4, as the usage duty Du. Also, if the direction of current flowing through the conductive path 11 is the second current direction, the selection unit 166 determines the maximum value Dn out of the first candidate duty D1, the third candidate duty D3, and the fifth candidate duty D5, as the usage duty Du. The PWM signal generation unit 52C shown in FIG. 3 generates the PWM signal Sp whose duty is set to the usage duty Du, and outputs this PWM signal Sp to the drive unit 54. Note that the cycle in which the control unit 52 determines the usage duty Du is a predetermined short period of time, and it is sufficient that the cycle is a feasible short time interval.

As show in FIG. 3, the drive unit 54 includes FET drive circuits 60 and 62 and a PWM inversion circuit 64. The FET drive circuit 60 outputs a PWM signal of comparable duty to the duty of the input PWM signal Sp (PWM signal output by the control unit 52 and whose duty is set to the usage duty Du). The PWM inversion circuit 64 functions to invert the PWM signal Sp output from the control unit 52. The PWM inversion circuit 64 is arranged between the FET drive circuit 62 and the connection point between the control unit 52 and the FET drive circuit 60. The PWM inversion circuit 64 outputs a low-level signal during the period in which the input PWM signal Sp (PWM signal output by the control unit 52) is a high-level signal, and outputs a high-level signal during the period in which the input PWM signal Sp is a low-level signal. The FET drive circuit 62 outputs a PWM signal of comparable duty to the duty of the input PWM signal (PWM signal output by the PWM inversion circuit 64). However, the FET drive circuit 62 outputs a PWM signal while setting the dead time such the ON time of the PWM signal output from the FET drive circuit 62 does not overlap with the ON time of the PWM signal output from the FET drive circuit 60.

In the first voltage conversion state, the drive unit 54 sets the switch 41 as the destination to which the signal from the FET drive circuit 60 is to be output, and sets the switch 42 as the destination to which the signal from the FET drive circuit 62 is to be output. In the first voltage conversion state, the FET drive circuit 60 provides an ON signal to the gate of the switch 41 during the period in which the input PWM signal Sp (PWM signal output by the control unit 52) is a high-level signal. Also, the FET drive circuit 60 provides an OFF signal to the gate of the switch 41 during the period in which the input PWM signal Sp is a low-level signal. The ON signal that the FET drive circuit 60 provides to the gate of the switch 41 is set to a voltage that can turn on the switch 41. In the first voltage conversion state, the FET drive circuit 62 provides an OFF signal to the gate of the switch 42 during the period in which the PWM signal Sp output by the control unit 52 is a high-level signal. Also, the FET drive circuit 62 provides an ON signal to the gate of the switch 42 while setting the dead time during the period in which the PWM signal Sp is a low-level signal.

In the second voltage conversion state, the drive unit 54 sets the switch 44 as the destination to which the signal from the FET drive circuit 60 is to be output, and sets the switch 43 as the destination to which the signal from the FET drive circuit 62 is to be output. In the second voltage conversion state, the FET drive circuit 60 provides an ON signal to the gate of the switch 44 during the period in which the input PWM signal Sp (PWM signal output by the control unit 52) is a high-level signal. Also, the FET drive circuit 60 provides an OFF signal to the gate of the switch 44 during the period in which the input PWM signal Sp is a low-level signal. The ON signal that the FET drive circuit 60 provides to the gate of the switch 44 is set to a voltage that can turn on the switch 44. In the second voltage conversion state, the FET drive circuit 62 provides an OFF signal to the gate of the switch 43 during the period in which the PWM signal Sp output by the control unit 52 is a high-level signal. Also, the FET drive circuit 62 provides an ON signal to the gate of the switch 43 while setting the dead time during the period in which the PWM signal Sp is a low-level signal.

Next, operations of the voltage conversion device 10 will be described. If the control unit 52 controls the voltage conversion unit 40 to the first voltage conversion state according to an instruction from an external device, the control unit 52 turns on the switch 43 and turns off the switch 44. Although the switches 43 and 44 in this case are switched on/off by the drive unit 54 according to the instruction given by the control unit 52, the control unit 52 can directly switch on/off the switches 43 and 44 in this case. Then, the control unit 52 causes the voltage conversion unit 40 to perform the first step-down operation and the first step-up operation. The first step-down operation is an operation for stepping down the voltage that is applied to the conductive path 11 through the on/off operation of the switch 41 and applying an output voltage to the conductive path 12. The first step-up operation is an operation for stepping up the voltage that is applied to the conductive path 12 through the on/off operation of the switch 42 and applying an output voltage to the conductive path 11.

If the control unit 52 causes the voltage conversion unit 40 to perform the first step-down operation and the first step-up operation to realize the first voltage conversion state, the control unit 52 sets the duty Da determined by the duty determination unit 111 to the duty D11 generated by the first generation unit 181. Also, in order to realize the first voltage conversion state, the control unit 52 sets the duty Db determined by the duty determination unit 112 to the duty D12 generated by the first generation unit 191. Then, if the switching unit 160 has been set to select “the larger value”, the control unit 52 selects the larger duty out of the duty Da and the duty Db as the first candidate duty D1. On the other hand, if the switching unit 160 has been set to select “the smaller value”, the control unit 52 selects the smaller duty out of the duty Da and the duty Db as the first candidate duty D1.

Then, if the direction of current flowing through the conductive path 11 is the first current direction, the selection unit 166 determines the minimum value Dm of the candidates that include the first candidate duty D1, the second candidate duty D2, and the fourth candidate duty D4, as the usage duty Du. On the other hand, if the direction of current flowing through the conductive path 11 is the second current direction, the selection unit 166 determines the maximum value Dn of the candidates that include the first candidate duty D1, the third candidate duty D3, and the fifth candidate duty D5, as the usage duty Du. The PWM signal generation unit 52C generates the PWM signal Sp whose duty is set to the usage duty Du, and outputs this PWM signal Sp to the drive unit 54.

In the first voltage conversion state, the drive unit 54 inputs, to the switch 41 (high-side switch), the PWM signal (first control signal) of the same duty as the PWM signal Sp that is output from the PWM signal generation unit 52C, the ON signal level of the PWM signal being a predetermined level. Then, in the first voltage conversion state, the drive unit 54 inputs, to the switch 42 (low-side switch), the ON/OFF signal (second control signal) corresponding to a signal obtained by inverting the PWM signal Sp. As a result of the first control signal and the second control signal being output in this manner, the voltage conversion unit 40 performs the first step-down operation and the first step-up operation.

If the control unit 52 controls the voltage conversion unit 40 to the second voltage conversion state according to an instruction from an external device, the control unit 52 turns on the switch 41 and turns off the switch 42. Although the switches 41 and 42 in this case are switched on/off by the drive unit 54 according to the instruction given by the control unit 52, the control unit 52 may directly switch on/off the switches 41 and 42. Then, the control unit 52 causes the voltage conversion unit 40 to perform the second step-down operation and the second step-up operation. The second step-down operation is an operation for stepping down the voltage that is applied to the conductive path 12 through the on/off operation of the switch 43 and applying an output voltage to the conductive path 11. The second step-up operation is an operation for stepping up the voltage that is applied to the conductive path 11 through the on/off operation of the switch 44 and applying an output voltage to the conductive path 12.

If the control unit 52 causes the voltage conversion unit 40 to perform the second step-down operation and the second step-up operation to realize the second voltage conversion state, the control unit 52 sets the duty Da determined by the duty determination unit 111 to the duty D13 generated by the second generation unit 182. Also, in order to realize the second voltage conversion state, the control unit 52 sets the duty Db determined by the duty determination unit 112 to the duty D14 generated by the second generation unit 192. Then, if the switching unit 160 has been set to select “the larger value”, the control unit 52 selects the larger duty out of the duty Da and the duty Db as the first candidate duty D1. On the other hand, if the switching unit 160 has been set to select “the smaller value”, the control unit 52 selects the smaller duty out of the duty Da and the duty Db as the first candidate duty D1.

Then, if the direction of current flowing through the conductive path 11 is the first current direction, the selection unit 166 determines the minimum value Dm of the candidates that include the first candidate duty D1, the second candidate duty D2, and the fourth candidate duty D4, as the usage duty Du. On the other hand, if the direction of current flowing through the conductive path 11 is the second current direction, the selection unit 166 determines the maximum value Dn of the candidates that include the first candidate duty D1, the third candidate duty D3, and the fifth candidate duty D5, as the usage duty Du. The PWM signal generation unit 52C generates the PWM signal Sp whose duty is set to the usage duty Du, and outputs the PWM signal Sp to the drive unit 54.

In the second voltage conversion state, the drive unit 54 inputs, to the switch 44 (low-side switch, second low-side switch), the PWM signal (fourth control signal, PWM control signal) of the same duty as the PWM signal Sp, the ON signal level of the PWM signal being a predetermined level. Then, in the second voltage conversion state, the drive unit 54 inputs, to the switch 43 (high-side switch, second high-side switch), the ON/OFF signal (third control signal, inverted control signal) corresponding to a signal obtained by inverting the PWM signal Sp. As a result of the third control signal (inverted control signal) and the fourth control signal (PWM control signal) being output in this manner, the voltage conversion unit 40 performs the second step-down operation and the second step-up operation.

The voltage conversion device 10 of this disclosure achieves the following effects, for example. In the voltage conversion device 10, the first duty is a duty for approximating the voltage value of the first conductive path to the voltage target value of the first conductive path, and the second duty is a duty for approximating the voltage value of the second conductive path to the voltage target value of the second conductive path. Also, the control unit 52 corresponding to the determination unit defines the first candidate duty D1 based on the larger value or the smaller value out of the value of the second duty out of the first duty and the second duty, and a value obtained by subtracting the first duty from 100 percent. The first duty is a duty for a step-up operation, and the second duty is a duty for a step-down operation. That is, if the first candidate duty D1 is used as the usage duty Du, the voltage conversion device 10 can always select one of the duty for a step-down operation and the duty for a step-up operation and perform a step-down operation or a step-up operation while maintaining an environment where both the duty for the step-down operation and the duty for the step-up operation can be determined. Also, based on the relationship between the first duty and the second duty, the voltage conversion device 10 can quickly switch whether to give priority to the step-down operation or the step-up operation when determining the first candidate duty D1. When one of the step-down operation and the step-up operation is being performed, if the duty balance changes to a state where priority is to be given to the other operation, the voltage conversion device 10 can update the first candidate duty D1 so as to give priority to the other duty immediately, for example.

If the voltage conversion device 10 operates using the first candidate duty D1 as the usage duty Du in this manner, the voltage conversion device 10 can smoothly switch between the step-down operation and the step-up operation based on the balance between the first duty and the second duty. However, under a predetermined condition, the voltage conversion device 10 can impose a limitation so as to give priority to the other candidate duty over the first candidate duty D1 when determining the usage duty Du. Specifically, the voltage conversion device 10 regards a direction from the first conductive path to the second conductive path as the first current direction, and regards the current direction opposite to the first current direction as the second current direction. Also, the voltage conversion device 10 defines the second candidate duty D2 for limiting the current value in the first current direction based on at least the current target value in the first current direction in “one” of the first conductive path and the second conductive path and the current value of the “one” of the conductive paths. Then, the voltage conversion device 10 determines the usage duty based on the minimum value of the candidates that include the first candidate duty D1 and the second candidate duty D2 if the direction of current flowing through at least one of the first conductive path and the second conductive path is the first current direction. That is, if the second candidate duty D2 is smaller than the first candidate duty D1 when current flows in the first current direction, the voltage conversion device 10 gives priority to the second candidate duty D2 having a relatively small duty. Thus, in this case, the voltage conversion device 10 can further limit the current in the first current direction, than in a case where at least the first candidate duty D1 is used as the usage duty. Also, the voltage conversion device 10 defines the third candidate duty D3 for limiting the current value in the second current direction based on at least the current target value in the second current direction in the “one” of the conductive paths and the current value of the “one” of the conductive paths. Then, the voltage conversion device 10 determines the usage duty based on the maximum value of the candidates that include the first candidate duty D1 and the third candidate duty D3 if the direction of current flowing through at least one of the first conductive path and the second conductive path is the second current direction. That is, if the third candidate duty D3 is larger than the first candidate duty D1 when current flows in the second current direction, the voltage conversion device 10 gives priority to the third candidate duty D3 having a relatively large duty. When current is flowing in the second current direction, if priority is given to the first candidate duty D1 and the usage duty decreases, the current further increases in the second current direction. However, the voltage conversion device 10 can suppress such a current increase. That is, the voltage conversion device 10 can increase the usage duty by giving priority to the third candidate duty D3 in the above-described case, and impose a limitation so as to approximate the current value in the second current direction to the current target value in the second current direction.

The voltage conversion device 10 can perform bidirectional voltage conversion using the full bridge circuit. Also, if the voltage conversion device 10 operates using the first candidate duty D1 as the usage duty the voltage conversion device 10 can smoothly switch between the step-down operation and the step-up operation based on the balance between the first duty and the second duty in the second voltage conversion state as well. Also, under a predetermined condition, the voltage conversion device 10 can impose a limitation so as to give priority to the other candidate duty over the first candidate duty D1 when determining the usage duty Du in the second voltage conversion state as well. Specifically, if the second candidate duty D2 is smaller than the first candidate duty D1 when current flows in the first current direction, the voltage conversion device 10 gives priority to the second candidate duty D2 having a relatively small duty in the second voltage conversion state as well. Thus, in this case, the voltage conversion device 10 can further limit the current in the first current direction, than in a case where at least the first candidate duty D1 is used as the usage duty Du. Also, if the third candidate duty D3 is larger than the first candidate duty D1 when current flows in the second current direction, the voltage conversion device 10 gives priority to the third candidate duty D3 having a relatively small duty in the second voltage conversion state as well. Thus, the voltage conversion device 10 can increase the usage duty by giving priority to the third candidate duty D3, and impose a limitation so as to approximate the current value in the second current direction to the current target value in the second current direction.

The voltage conversion device 10 defines a second candidate duty D2 based on the smaller deviation out of the first current deviation ΔI11 and the second current deviation ΔI21. Therefore, the voltage conversion device 10 can define the second candidate duty D2 that can further limit the current in the first current direction, based on the condition of the one of the two conductive paths where the current in the first current direction is to be further suppressed. Also, the voltage conversion device defines the third candidate duty D3 based on the larger deviation out of the third current deviation ΔI12 and the fourth current deviation ΔI22. Therefore, the voltage conversion device 10 can define the third candidate duty D3 that can further limit the current in the second current direction, based on the conditions of the two conductive paths.

The voltage conversion device 10 defines the fourth candidate duty D4 for limiting the power value in the first current direction based on at least the power target value in the first current direction in the “one” of the conductive paths and the power value of the “one” of the conductive paths. Then, if the current direction is the first current direction, the voltage conversion device 10 determines the usage duty Du based on the minimum value Dm of the candidates that include the first candidate duty D1, the second candidate duty D2, and the fourth candidate duty D4. That is, if the fourth candidate duty D4 is smaller than the first candidate duty D1 and the second candidate duty D2 when current flows in the first current direction, the voltage conversion device 10 gives priority to the fourth candidate duty D4 having a relatively small duty. Thus, in this case, the voltage conversion device 10 can further limit the power in the first current direction, than in a case where at least the first candidate duty D1 or the second candidate duty D2 is used as the usage duty Du. Also, the voltage conversion device 10 defines the fifth candidate duty D5 for limiting the power in the second current direction based on at least the power target value in the second current direction in the “one” of the conductive paths and the power value of the “one” of the conductive paths. Then, if the current direction is the second current direction, the voltage conversion device 10 determines the usage duty Du based on the maximum value Dn of the candidates that include the first candidate duty D1, the third candidate duty D3, and the fifth candidate duty D5. That is, if the fifth candidate duty D5 is larger than the first candidate duty D1 and the third candidate duty D3 when current flows in the second current direction, the voltage conversion device 10 gives priority to the fifth candidate duty D5 having a relatively large duty. When current is flowing in the second current direction, if priority is given to the first candidate duty D1 or the third candidate duty D3 and the usage duty decreases, the power further increases in the second current direction. However, the voltage conversion device 10 can suppress such a power increase. That is, the voltage conversion device 10 can increase the usage duty by giving priority to the fifth candidate duty D5 in the above-described case, and impose a limitation so as to approximate the power value in the second current direction to the power target value in the second current direction.

The voltage conversion device 10 defines the fourth candidate duty D4 based on the smaller deviation out of the first power deviation ΔP11 and the second power deviation ΔP21. Therefore, the voltage conversion device 10 can define the fourth candidate duty D4 that can further limit the power in the first current direction, based on the condition of the one of the two conductive paths where the power in the first current direction is to be further suppressed. Also, the voltage conversion device 10 defines the fifth candidate duty D5 based on the larger deviation out of the third power deviation ΔP12 and the fourth power deviation ΔP22. Therefore, the voltage conversion device 10 can define the fifth candidate duty D5 that can further limit the power in the second current direction, based on the conditions of the two conductive paths.

The control unit 52 corresponding to the determination unit includes the switching unit 160 that switches whether or not to define the first candidate duty D1 based on the “large value” or the “small value”. Therefore, the voltage conversion device 10 can select whether to give priority to the step-down operation or the step-up operation in the case of conflict.

### Other Embodiments

The present disclosure is not limited to the embodiments illustrated in the above description and drawings. All combinations of the features of embodiments described above and below are possible as long as there are no inconsistencies. Also, any of the features of embodiments described above and below can also be omitted if not explicitly indicated as being essential. Furthermore, the above-described embodiments may be modified as follows.

Although the selection unit 166 determines whether the current direction is the first current direction or the second current direction according to the direction of the current value of the conductive path 11 in the embodiments, the selection unit 166 may determine whether it is the first current direction or the second current direction according to the direction of the current value of the conductive path 12.

Although a configuration in which it is possible to switch between the first voltage conversion state and the second voltage conversion state is adopted in the embodiments, a configuration in which only one of the first voltage conversion state and the second voltage conversion state is selected may be adopted.

Although a voltage conversion unit constituted as a full bridge circuit is described as an example in the embodiments, the voltage conversion unit may be constituted as a half bridge circuit in which a portion of the switch 43 is short-circuited and a portion of the switch 44 is omitted. In this case, the control unit 52 may perform control such that only operations in the first voltage conversion state are performed. Alternatively, the voltage conversion unit may also be constituted as a half bridge circuit in which a portion of the switch 41 is short-circuited and a portion of the switch 42 is omitted. In this case, the control unit 52 may perform control such that only operations in the second voltage conversion state are performed.

Although the functions shown in FIGS. 3 to 7 are realized through digital processing performed by the control unit 52 in the embodiments, of course, the functions shown in FIGS. 3 to 7 may be realized in a form in which an analog circuit is included. The functions shown in FIGS. 4 to 7 may be realized by an analog circuit, for example.

Although the computation units 181B, 182B, 191B, 192B, 121B, 122B, 131B, 132B, 141B, 142B, 151B, and 152B perform feedback computation through PI computation in the embodiments, computation may be performed using another method such as a PID computation method.

Although a switching unit is provided in the embodiments, the switching unit may be omitted. In this case, the selection unit 116 may always select only the maximum value (larger value), or may always select only the minimum value (smaller value).

Although the minimum value Dm or the maximum value Dn is used as the usage duty Du in the embodiments, a value obtained by performing some kind of correction on the minimum value Dm or the maximum value Dn may be used as the usage duty Du.

Note that the embodiments disclosed herein are to be considered illustrative in all respects and not restrictive. The scope of the disclosure is not limited to the embodiments disclosed herein, and all changes that fall within a range defined by the claims or the range of equivalency to the claims are intended to be embraced therein.

1. A voltage conversion device comprising:
a voltage conversion unit that includes a high-side switch, a low-side switch, and an inductor, and that is configured to perform voltage conversion between a first conductive path and a second conductive path;
a first voltage value detection unit configured to detect a first voltage value that is a voltage value of the first conductive path;
a first current value detection unit configured to detect a first current value that is a value of current flowing through the first conductive path;
a second voltage value detection unit configured to detect a second voltage value that is a voltage value of the second conductive path;
a second current value detection unit configured to detect a second current value that is a value of current flowing through the second conductive path;
a determination unit configured to determine a usage duty based on the first voltage value, the second voltage value, the first current value, and the second current value; and
a drive unit configured to input a first control signal that is based on the usage duty determined by the determination unit to the high-side switch, and to input a second control signal that is based on a signal obtained by inverting the first control signal to the low-side switch,
wherein the voltage conversion unit is configured to perform at least a step-down operation for stepping down a voltage applied to the first conductive path through an on/off operation of the high-side switch and applying an output voltage to the second conductive path, and a step-up operation for stepping up a voltage applied to the second conductive path through an on/off operation of the low-side switch and applying an output voltage to the first conductive path, and
the determination unit is configured to
define a first candidate duty based on a larger value or a smaller value out of a value obtained by subtracting a first duty from 100 percent, and a value of a second duty out of the first duty and the second duty, the first duty being a duty for approximating the voltage value of the first conductive path to a voltage target value of the first conductive path, and the second duty being a duty for approximating the voltage value of the second conductive path to a voltage target value of the second conductive path,
define a second candidate duty for limiting a current value in a first current direction from the first conductive path to the second conductive path, based on at least a current target value in the first current direction in one of the first conductive path and the second conductive path and a current value of the one of the conductive paths,
define a third candidate duty for limiting a current value in a second current direction opposite to the first current direction, based on at least a current target value in the second current direction in the one of the conductive paths and the current value of the one of the conductive paths,
determine the usage duty based on the minimum value of candidates that include the first candidate duty and the second candidate duty if the direction of current flowing through at least one of the first conductive path and the second conductive path is the first current direction, and
determine the usage duty based on the maximum value of candidates that include the first candidate duty and the third candidate duty if the direction of current flowing through at least one of the first conductive path and the second conductive path is the second current direction.

2. The voltage conversion device according to claim 1, wherein the voltage conversion unit includes a full bridge circuit provided with the high-side switch, the low-side switch, the inductor, a second high-side switch, and a second low-side switch,
the voltage conversion unit is configured to switch between a first voltage conversion state where at least the step-down operation that is based on the on/off operation of the high-side switch and the step-up operation that is based on the on/off operation of the low-side switch are performed, and a second voltage conversion state where at least a second step-down operation for stepping down the voltage applied to the second conductive path through an on/off operation of the second high-side switch and applying an output voltage to the first conductive path and a second step-up operation for stepping up the voltage applied to the first conductive path through an on/off operation of the second low-side switch and applying an output voltage to the second conductive path are performed, and
the drive unit is configured to input the first control signal to the high-side switch and to input the second control signal to the low-side switch in the first voltage conversion state, and to input a fourth control signal that is based on the usage duty determined by the determination unit to the second low-side switch and to input a third control signal that is based on a signal obtained by inverting the fourth control signal to the second high-side switch in the second voltage conversion state.

3. A voltage conversion device comprising:
a voltage conversion unit that includes a high-side switch, a low-side switch, and an inductor, and that is configured to perform voltage conversion between a first conductive path and a second conductive path;
a first voltage value detection unit configured to detect a first voltage value that is a voltage value of the first conductive path;
a first current value detection unit configured to detect a first current value that is a value of current flowing through the first conductive path;
a second voltage value detection unit configured to detect a second voltage value that is a voltage value of the second conductive path;
a second current value detection unit configured to detect a second current value that is a value of current flowing through the second conductive path;
a determination unit configured to determine a usage duty based on the first voltage value, the second voltage value, the first current value, and the second current value; and
a drive unit configured to input a PWM control signal that is based on the usage duty determined by the determination unit to the low-side switch, and to input an inverted control signal that is based on a signal obtained by inverting the PWM control signal to the high-side switch,
wherein the voltage conversion unit is configured to perform at least a step-down operation for stepping down a voltage applied to the second conductive path through an on/off operation of the high-side switch and applying an output voltage to the first conductive path, and a step-up operation for stepping up a voltage applied to the first conductive path through an on/off operation of the low-side switch and applying an output voltage to the second conductive path, and
the determination unit is configured to
define a first candidate duty based on a larger value or a smaller value out of a value obtained by subtracting a first duty from 100 percent, and a value of a second duty out of the first duty and the second duty, the first duty being a duty for approximating the voltage value of the first conductive path to a voltage target value of the first conductive path, and the second duty being a duty for approximating the voltage value of the second conductive path to a voltage target value of the second conductive path,
define a second candidate duty for limiting a current value in a first current direction, based on at least a current target value in the first current direction in one of the first conductive path and the second conductive path and a current value of the one of the conductive paths,
define a third candidate duty for limiting a current value in a second current direction opposite to the first current direction, based on at least a current target value in the second current direction in the one of the conductive paths and the current value of the one of the conductive paths,
determine the usage duty based on the minimum value of candidates that include the first candidate duty and the second candidate duty if the direction of current flowing through at least one of the first conductive path and the second conductive path is the first current direction, and
determine the usage duty based on the maximum value of candidates that include the first candidate duty and the third candidate duty if the direction of current flowing through at least one of the first conductive path and the second conductive path is the second current direction.

4. The voltage conversion device according to claim 1, wherein the determination unit is configured to define the second candidate duty based on a smaller deviation out of a first current deviation and a second current deviation, and to define the third candidate duty based on a larger deviation out of a third current deviation and a fourth current deviation,
the first current deviation is a deviation obtained by subtracting the current value of the one of the conductive paths from the current target value in the first current direction in the one of the conductive paths,
the second current deviation is a deviation obtained by subtracting a current value of the other conductive path that is different from the one of the first conductive path and the second conductive path, from the current target value in the first current direction in the other conductive path,
the third current deviation is a deviation obtained by subtracting the current value of the one of the conductive paths from the current target value in the second current direction in the one of the conductive paths, and
the fourth current deviation is a deviation obtained by subtracting the current value of the other conductive path from the current target value in the second current direction in the other conductive path.

5. The voltage conversion device according to claim 1, wherein the determination unit is configured to:
define a fourth candidate duty for limiting power in the first current direction based on at least a power target value in the first current direction in the one of the conductive paths and a power value of the one of the conductive paths,
define a fifth candidate duty for limiting power in the second current direction based on at least a power target value in the second current direction in the one of the conductive paths and the power value of the one of the conductive paths,
determine the usage duty based on the minimum value of candidates that include the first candidate duty, the second candidate duty, and the fourth candidate duty if the direction of current flowing through at least one of the first conductive path and the second conductive path is the first current direction, and
determine the usage duty based on the maximum value of candidates that include the first candidate duty, the third candidate duty, and the fifth candidate duty if the direction of current flowing through at least one of the first conductive path and the second conductive path is the second current direction.

6. The voltage conversion device according to claim 5, wherein the determination unit is configured to define the fourth candidate duty based on a smaller deviation out of a first power deviation and a second power deviation, and to define the fifth candidate duty based on a larger deviation out of a third power deviation and a fourth power deviation,
the first power deviation is a deviation obtained by subtracting the power value of the one of the conductive paths from the power target value in the first current direction in the one of the conductive paths,
the second power deviation is a deviation obtained by subtracting a power value of the other conductive path that is different from the one of the first conductive path and the second conductive path, from a power target value of the other conductive path,
the third power deviation is a deviation obtained by subtracting the power value of the one of the conductive paths from the power target value in the second current direction in the one of the conductive paths, and
the fourth power deviation is a deviation obtained by subtracting the power value of the other conductive path from a power target value in the second current direction in the other conductive path.

7. The voltage conversion device according to claim 1, wherein the determination unit includes a switching unit configured to switch whether to define the first candidate duty based on the larger value or the smaller value.

8. The voltage conversion device according to claim 1, wherein the determination unit is configured to define the second candidate duty based on a smaller deviation out of a first current deviation and a second current deviation, and to define the third candidate duty based on a larger deviation out of a third current deviation and a fourth current deviation,
the first current deviation is a deviation obtained by subtracting the current value of the one of the conductive paths from the current target value in the first current direction in the one of the conductive paths,
the second current deviation is a deviation obtained by subtracting a current value of the other conductive path that is different from the one of the first conductive path and the second conductive path, from the current target value in the first current direction in the other conductive path,
the third current deviation is a deviation obtained by subtracting the current value of the one of the conductive paths from the current target value in the second current direction in the one of the conductive paths, and
the fourth current deviation is a deviation obtained by subtracting the current value of the other conductive path from the current target value in the second current direction in the other conductive path.

9. The voltage conversion device according to claim 3, wherein the determination unit is configured to define the second candidate duty based on a smaller deviation out of a first current deviation and a second current deviation, and to define the third candidate duty based on a larger deviation out of a third current deviation and a fourth current deviation,
the first current deviation is a deviation obtained by subtracting the current value of the one of the conductive paths from the current target value in the first current direction in the one of the conductive paths,
the second current deviation is a deviation obtained by subtracting a current value of the other conductive path that is different from the one of the first conductive path and the second conductive path, from the current target value in the first current direction in the other conductive path,
the third current deviation is a deviation obtained by subtracting the current value of the one of the conductive paths from the current target value in the second current direction in the one of the conductive paths, and
the fourth current deviation is a deviation obtained by subtracting the current value of the other conductive path from the current target value in the second current direction in the other conductive path.

10. The voltage conversion device according to claim 2, wherein the determination unit is configured to:
define a fourth candidate duty for limiting power in the first current direction based on at least a power target value in the first current direction in the one of the conductive paths and a power value of the one of the conductive paths,
define a fifth candidate duty for limiting power in the second current direction based on at least a power target value in the second current direction in the one of the conductive paths and the power value of the one of the conductive paths,
determine the usage duty based on the minimum value of candidates that include the first candidate duty, the second candidate duty, and the fourth candidate duty if the direction of current flowing through at least one of the first conductive path and the second conductive path is the first current direction, and
determine the usage duty based on the maximum value of candidates that include the first candidate duty, the third candidate duty, and the fifth candidate duty if the direction of current flowing through at least one of the first conductive path and the second conductive path is the second current direction.

11. The voltage conversion device according to claim 3, wherein the determination unit is configured to:
define a fourth candidate duty for limiting power in the first current direction based on at least a power target value in the first current direction in the one of the conductive paths and a power value of the one of the conductive paths,
define a fifth candidate duty for limiting power in the second current direction based on at least a power target value in the second current direction in the one of the conductive paths and the power value of the one of the conductive paths,
determine the usage duty based on the minimum value of candidates that include the first candidate duty, the second candidate duty, and the fourth candidate duty if the direction of current flowing through at least one of the first conductive path and the second conductive path is the first current direction, and
determine the usage duty based on the maximum value of candidates that include the first candidate duty, the third candidate duty, and the fifth candidate duty if the direction of current flowing through at least one of the first conductive path and the second conductive path is the second current direction.

12. The voltage conversion device according to claim 4, wherein the determination unit is configured to:
define a fourth candidate duty for limiting power in the first current direction based on at least a power target value in the first current direction in the one of the conductive paths and a power value of the one of the conductive paths,
define a fifth candidate duty for limiting power in the second current direction based on at least a power target value in the second current direction in the one of the conductive paths and the power value of the one of the conductive paths,
determine the usage duty based on the minimum value of candidates that include the first candidate duty, the second candidate duty, and the fourth candidate duty if the direction of current flowing through at least one of the first conductive path and the second conductive path is the first current direction, and
determine the usage duty based on the maximum value of candidates that include the first candidate duty, the third candidate duty, and the fifth candidate duty if the direction of current flowing through at least one of the first conductive path and the second conductive path is the second current direction.

13. The voltage conversion device according to claim 2, wherein the determination unit includes a switching unit configured to switch whether to define the first candidate duty based on the larger value or the smaller value.

14. The voltage conversion device according to claim 3, wherein the determination unit includes a switching unit configured to switch whether to define the first candidate duty based on the larger value or the smaller value.

15. The voltage conversion device according to claim 4, wherein the determination unit includes a switching unit configured to switch whether to define the first candidate duty based on the larger value or the smaller value.

16. The voltage conversion device according to claim 5, wherein the determination unit includes a switching unit configured to switch whether to define the first candidate duty based on the larger value or the smaller value.

17. The voltage conversion device according to claim 6, wherein the determination unit includes a switching unit configured to switch whether to define the first candidate duty based on the larger value or the smaller value.
